(19) United States
(12) Patent Application Publication
(10) Pub. No.: US 2011/0218667 A1
(43) Pub. Date: Sep. 8, 2011

(54) FORMING MACHINE FOR PRODUCING FORMED PARTS

(75) Inventors: Uwe-Peter Weigmann, Nuertingen (DE); Wolfgang Krueger, Trochtelfingen (DE)

(73) Assignee: WAFIOS AG, Reutlingen (DE)

(21) Appl. No.: 12/900,652

(22) Filed: Oct. 8, 2010

(30) Foreign Application Priority Data
Mar. 2, 2010 (DE) 10 2010 010 743.3

(51) Int. Cl. G06F 19/00

(52) U.S. Cl. 700/167

(57) ABSTRACT

A forming machine for producing formed parts by forming wire, tube or other elongated workpieces has a plurality of driven machine axes, a drive system having a plurality of electrical drives for driving the machine axes, a control device for the coordinated control of operating movements of the machine axes in a production process according to an operating program specific to the production process, and a speed setting device for setting the operating speed of the forming machine for the production process. An operator information system is used to determine and output at least one item of operator information which makes it possible for the operator to control the operating speed with respect to at least one control criterion which represents the energy consumption required for production.

### RELATED APPLICATION

This application claims priority of German Patent Application No. 10 2010 010 743.3, filed on Mar. 2, 2010, the subject matter of which is incorporated herein by reference.

### TECHNICAL FIELD

This disclosure relates to forming machines for producing formed parts by forming wire, tube or other elongated workpieces.

### BACKGROUND

Forming machines are machine tools which can produce relatively small or relatively large series of formed parts with partially complex geometry from semi-finished products, such as wire, tube, strip or the like, predominantly by forming with the aid of suitable tools in an automatic production process. A forming machine may be, for example, a bending machine for producing bent parts from wire material, tape material or tube material or a spring machine for producing compression springs, tension spring bodies, leg springs or other spring-like formed parts. A forming machine may also be designed, for example, as a wire nail machine for the mass production of screws, nails, rivets or the like.

A computer numerically controlled forming machine has a plurality of machine axes, a drive system having a plurality of electrical drives for driving the machine axes and a control device with an integrated computer for the coordinated control of operating movements of the machine axes in a production process according to a computer-readable operating program specific to the production process. This operating program stores, inter alia, the desired geometrical shape of the finished formed part as well as the operating steps provided for producing the latter and the sequence of the steps in the form of NC sets which may be programmed in different ways (for example, close to the machine or remote from the machine). The operating program is executed for each formed part in a series during the production process, is converted into control signals for the drives and thus produces coordinated movements of the machine axes.

The productivity of the production process and thus the costs of the formed parts produced are decisively concomitantly determined by the production capacity, that is to say the number of completed formed parts per unit time. The production capacity belongs to the most important production data relating to the production process. In principle, there is a desire for production capacities which are as high as possible. The production capacity which can be achieved during production depends on the operating speed of the forming machine, that is to say on that speed at which the steps of the operating program are converted overall into a sequence of movements of the machine axes. However, the production capacity which depends on the operating speed cannot be increased as desired since a sufficient degree of quality of produced formed parts often can no longer be ensured when the operating speed increases beyond certain machine-dictated and/or formed-part-dictated limits.

For this reason, forming machines generally contain a speed setting device for setting the operating speed of the forming machine for the production process. The operating speed which has been set has the same effect for all programmed production steps of a production process in the sense of scaling the programmed speed.

Well-equipped forming machines contain a display device which displays important production data for the operator, for example, the current production capacity, the cycle time (time needed to produce a formed part) corresponding to the currently set operating speed, the production time remaining until the desired number of parts has been completed, etc.

Some forming machines have an online measuring system for generating a quality signal which represents the production quality of the formed part produced. The length of the finished formed parts is measured, for example. The quality signal is processed for the purpose of controlling a sorting device to sort the produced formed parts, immediately after completion, into good parts (length inside the tolerances) and bad parts (length outside the tolerances).

In some systems, the individual measurement results from the online measurement can be graphically displayed together for a multiplicity of measured formed parts in the form of a variation curve together with tolerance limits for the production process to allow an operator to have immediate control of whether the production process provides the desired quality or whether changes to the process are necessary.

It could therefore be helpful to improve a forming machine of the type mentioned at the outset in such a manner that controlled operation of the forming machine with respect to numerous boundary conditions relevant to the production process is possible. It could also be possible to enable cost-effective production with a high degree of production quality.

### SUMMARY

We provide forming machines that produce formed parts by forming wire, tube or other elongated workpieces including a plurality of driven machine axes, a drive system including a plurality of electrical drives that drive the machine axes, a control device that controls in a coordinated fashion operating movements of the machine axes in a production process according to an operating program selected for the production process, a speed setting device provided to set an operating speed of the forming machine for the production process, and an operator information system that determines and outputs at least one item of operator information that controls the operating speed with respect to at least one control criterion related to energy consumption required for production.

We also provide forming machines configured to produce formed parts by forming wire, tube or other elongated workpieces including a plurality of driven machine axes, a drive system including a plurality of electrical drives that drive the machine axes, a control device that controls in a coordinated fashion operating movements of the machine axes in a production process according to an operating program selected for the production process, a speed setting device that sets an operating speed of the forming machine for the production process, and an operator information system that determines and outputs at least one item of operator information which represents a process parameter characteristic of the programmed production process as a function of the operating speed.

### BRIEF DESCRIPTION OF THE DRAWINGS

FIG. 1 shows a schematic side view of the bending unit of a bending machine having drives for the machine axes and devices for controlling and operating the bending machine.

FIG. 2 schematically shows essential components of a drive system having an intermediate circuit.

FIG. 3 shows a section of the screen surfaces of a display unit of the operator information system in a first operating mode.

FIG. 4 shows the section of the screen surface of a display unit of the operator information system, as shown in FIG. 4, in a second operating mode.

### DETAILED DESCRIPTION

It will be appreciated that the following description is intended to refer to specific examples of structure selected for illustration in the drawings and is not intended to define or limit the disclosure, other than in the appended claims.

We provide forming machines configured to produce formed parts by forming wire, tube or other elongated workpieces, comprising: a plurality of machine axes; a drive system comprising a plurality of electrical drives to drive the machine axes; a control device to control in a coordinated fashion operating movements of the machine axes in a production process according to an operating program specific to the production process; a speed setting device provided to set an operating speed of the forming machine for the production process; and an operator information system configured to determine and output at least one item of operator information for controlling the operating speed with respect to at least one control criterion which takes into account an energy consumption required for production.

Our forming machines may contain an operator information system for determining and outputting at least one item of operator information to control the operating speed with respect to at least one control criterion which takes into account the energy consumption required for production. This is not a control criterion aimed at maximizing the production capacity. As a result, an operator of the forming machine is able to selectively set the forming machine on the basis of reproducible, qualitative and/or quantitative information in such a manner that the production process is also controlled with respect to energy efficiency. In particular, the machine makes it possible for an operator to set the forming machine in such a manner that unnecessary consumption of electrical energy is avoided and/or the consumption of electrical energy is increased only to such an extent that the increase in the energy consumption is also expressed in an actually usable increase in the production capacity and/or in an increase in the production quality. In this case, a production process which is controlled with respect to energy efficiency is intended to reach a compromise which is as favorable as possible with respect to a plurality of boundary conditions which include an energy consumption which is as favorable as possible. A power consumption which is as low as possible is advantageous, inter alia, for reasons of cost, but also for reasons of environmental protection.

The drive system may have an intermediate circuit which connects a plurality of drives, in particular all drives, and one or more electrical supply units of the drive system to one another, and the control device of the forming machine is set up to detect an intermediate circuit state signal which represents the utilization state of the intermediate circuit and to process the signal for the purposes of control. The intermediate circuit state signal, for example, the intermediate circuit voltage prevailing in the intermediate circuit or an electrical signal derived therefrom, can be supplied to a suitable input of the control device for this purpose.

Intermediate circuits for recovering energy are known per se in machine tools. When braking the movement of a machine axis, electrical energy can be recovered using a generator. The energy fed back into the intermediate circuit can be buffered in capacitor batteries or other electrical energy stores of the intermediate circuit and can be made available to accelerating drives in phases with a high power requirement. Excess electrical energy which cannot be made available to other drives by redistribution is either fed back into the supply network with the acceptance of a loss of energy or is consumed in a braking resistor or the like associated with the intermediate circuit. These operations of redistributing electrical energy via the intermediate circuit and possibly the useless consumption of energy take place automatically and in a manner which is invisible to an operator in conventional drive systems with an intermediate circuit. This information is thus used to better control the operation of the forming machine.

The operator information system may be set up to control a display which represents the current utilization state of the intermediate circuit on a display unit of the forming machine on the basis of the intermediate circuit state signal. In this case, the display is expediently designed in such a manner that the operator can discern at a glance whether the intermediate circuit is being operated in the pure storage and redistribution mode which is favorable in terms of energy or whether the intake capacity of the intermediate circuit is temporarily exceeded, with the result that excess energy arises which cannot be used inside the drive system for the production process, but rather must be rejected. The operator can then set the operating speed, for example, in such a manner that the production of excess energy is avoided.

It is also possible to detect the intermediate circuit state signal which represents the utilization state of the intermediate circuit and to process the signal in such a manner that the operating speed is automatically limited by the control device in such a manner that the intermediate circuit is operated only in the pure storage and redistribution mode and no excess energy arises. This may possibly be effected by bypassing the operator, possibly even without an operator information system making this information visible or audible.

With respect to controlling the energy efficiency, that portion of electrical energy which cannot be used to operate other drives for the production process by redistribution using the intermediate circuit should be kept as low as possible. Therefore, in some examples, the operator information system is set up to process an excess energy signal which represents this excess energy, with the result that an operator can discern when and possibly the extent to which excess energy arises for an operating speed which has been set. For this purpose, the operator information system can be set up to control a display, which qualitatively (for example, in the sense of a pure yes/no display) or quantitatively represents the amount of excess electrical energy which arises, on a display unit of the forming machine. In some examples, the operator information system is set up to process the excess signal and to use it to determine a process parameter which represents the amount of excess energy consumed, that is to say a quantitative measure.

The display which represents the current utilization state of the intermediate circuit may be combined with a display which represents the consumption of excess energy. The operator can discern in a particularly simple manner when the utilization of the intermediate circuit approaches the utilization limit, as the operating speed increases, and possibly exceeds the limit in such a manner that excess electrical energy arises. A combined display therefore makes it possible to set the operating speed in an anticipatory and precise manner to avoid the consumption of excess energy.

The measures proposed here for detecting and processing, in particular for displaying, the operations in an electrical intermediate circuit are possible with little outlay on apparatus in some conventional drive systems having an intermediate circuit since some conventional drive systems having an intermediate circuit already have (previously unused) connections at which the electrical intermediate circuit voltage prevailing in the intermediate circuit can be tapped off. The intermediate circuit voltage can be tapped off and made available to the control device. It can be compared, for example, with one or more comparison values to generate the abovementioned intermediate circuit state signal and/or the excess energy signal which can then be processed further using software and can be displayed on a screen or another display device. The great technological benefit can therefore be achieved possibly with relatively little outlay.

Further measures can be implemented in forming machines irrespective of whether or not their drive system has an intermediate circuit. Some examples have a power detection device for detecting the electrical power consumed by the forming machine and for generating a power signal which represents this power. The electrical power (energy per unit time) currently being consumed by the entire forming machine can therefore be detected using the power detection device and can be taken into account when controlling the operation of the forming machine.

The operator information system may be set up to process the power signal and to use it to determine a process parameter which is proportional to the electrical energy needed by the forming machine for each formed part produced. This process parameter can be used, for example, to automatically control the forming machine to limit operation, for example, in such a manner that a predefined maximum value for the energy for each formed part is not exceeded.

If the electrical power consumed by the forming machine is detected at different operating speeds, the dependence of the process parameter “energy per formed part” on the operating speed can be determined using the power signals detected in the process. In this case, the power signal can be used to determine an item of operator information which represents the process parameter “energy per formed part” as a function of the operating speed. This operator information can be displayed on a screen, for example, in the form of a graph.

It is also possible to have an online measuring system to generate at least one quality signal which represents the production quality of the formed part produced. The online measuring system may have, for example, a camera system with a connected image processing system which can detect the geometry of the produced formed parts in real time and can be compared with the desired geometry to immediately detect produced formed parts as “bad parts” and to reject those parts when tolerances are exceeded. In some instances, the operator information system may be set up to process the quality signal and use the signal to determine a process parameter which is proportional to a variation in the production quality within a definable number of produced formed parts. This process parameter and corresponding data can be processed to form an item of operator information which represents this process parameter as a function of the operating speed. An operator can thus immediately discern how the operating speed affects the quality of the produced formed parts. If the operator discerns thereby that the quality is particularly good or particularly poor in certain operating speed ranges, the operator can attempt to avoid the unfavorable operating speed ranges and to set, possibly in combination with the consideration of further process parameters, such an operating speed which is controlled not only with respect to energy efficiency and possibly other criteria, but also with respect to the production quality.

It may be particularly advantageous if an operator information system is set up in such a manner that at least one item of operator information determines and indicates a process parameter characteristic of the programmed production process as a function of the operating speed. This operator information is independent of the currently set operating speed and can be displayed graphically, for example, in the form of a two-dimensional graph, for example, in the form of an x-y graph in which a suitable measure of the operating speed (for example, the override speed) is plotted on one axis and values for the corresponding process parameter are plotted on the other axis. An x-y graph may be displayed, for example, as a scatter diagram, a line graph, a bar chart, a column chart or a histogram. This form of two-dimensional graphical display of operator information presents a functional relationship between the operating speed and the process parameters in a manner which is particularly easy for an operator to understand and therefore can be immediately used, with the result that the operator is provided with a precise representation of the influence of the operating speed on the process parameter and can accordingly set the operating speed in an optimal manner. More complex dependences can also be displayed, if appropriate, with the aid of quasi-three-dimensional diagrams.

This type of presentation of operator information can be provided in all forming machines of the generic type and can possibly also entail benefits if no operator information relating to the energy consumption is determined and/or displayed.

The operator information system may be set up to simultaneously display at least two of the following items of operator information in at least one operating mode:
a current utilization state of an intermediate circuit;
the amount of excess electrical energy arising in an intermediate circuit;
the excess energy consumed in an intermediate circuit as a function of the operating speed;
the electrical energy consumed by the forming machine for each produced formed part as a function of the operating speed;
a variation in the production quality within a definable number of produced formed parts as a function of the operating speed.

As a result, the operator can very easily set the operating speed in an optimal manner with regard to a plurality of possibly competing criteria.

The data which can be used to describe a functional relationship between the operating speed and one or more process parameters influenced by the latter can be recorded during production and can possibly be updated again and again during the production process. It is also possible to detect the relationship in automated fashion during set-up operation before actual production begins.

Selected representative examples of our forming machines in particular are explained below using an example of a forming machine which is designed as a CNC wire bending machine with controlled machine axes.

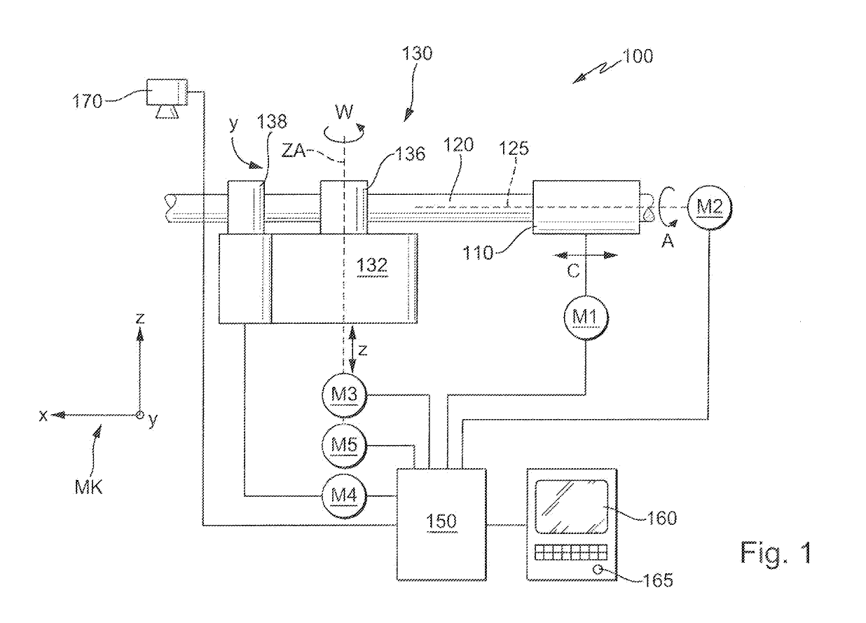

FIG. 1 shows a schematic side view of a bending unit 100 of a CNC bending machine having the associated drives of the drive system for the machine axes and having devices for controlling and operating the bending machine. The bending unit has a feed unit 110 which is used to feed a still unbent workpiece 120 (round wire) into the engagement region of a bending tool 130 which is also referred to as a bending head below. The feed unit may have, for example, a gripper or tongs or may have feed rollers which convey a still unbent section of the workpiece, which comes from a stock of workpieces (for example, wire coil, reel or the like) and is passed through an interposed straightening unit, in the direction of the bending tool.

The bending tool 130 has a mandrel plate 132 which is rotatable about a central axis ZA and on the top side of which two bending mandrels (only bending mandrel 136 can be seen; the other bending mandrel is behind the workpiece in the viewing direction) are arranged at a distance from one another, as well as a bending pin 138 arranged at a radial distance from the central axis ZA and is pivotable about the central axis of the mandrel plate 132.

The bending head 130 can be positioned linearly in a manner perpendicular to the feed axis 125 (or perpendicular to the z direction of the machine coordinate system MK) in two directions which are perpendicular to one another (x and y directions of the machine coordinate system MK). The workpiece is rotatable about its workpiece axis and can be positioned in the axial direction (parallel to the z direction). The machine axes which are driven in a controlled manner and are each denoted using capital letters (for example A, B, C, W, Z) should be distinguished from the coordinate axes of the machine coordinate system which are denoted using lower case letters.

A conventional designation of the machine axes is explained using FIG. 1. The feed unit 110 can be moved in a rectilinear manner parallel to the workpiece axis (and thus parallel to the x axis) with the aid of a linear C axis (sometimes referred to as gripper feed). For this purpose, the drive is effected with the aid of a servomotor M1. (Theoretically) unlimited rotation of the workpiece about the workpiece axis 125 is possible with the aid of the A axis (workpiece axis of rotation), a servomotor M2 being used as the drive in this case. The other machine axes are associated with the bending tool 130. The bending head 130 is rotatable without limitation about the central axis ZA (which runs parallel to the z axis of the machine coordinate system) with the aid of a servomotor M3 of the W axis. The bending pin 138 can be pivoted without limitation about the central axis ZA of the bending head with the aid of a servomotor M4 of the Y axis. In this case, the central axis ZA defines the center point of bending and is therefore also referred to as a bending axis. The bending tool can be linearly moved, as a whole, in two directions perpendicular to the workpiece axis, namely using a Z axis running parallel to the central axis ZA with the aid of a motor M5 and using a B axis (not shown) running perpendicular to the Z axis with the aid of a motor (not illustrated). The motors for linear movements may each be servomotors or electrical linear drives (direct drives).

The fully bent formed part is separated from the still unbent workpiece section using an electrically or hydraulically driven separating device (not illustrated).

All of the drives for the machine axes are electrically connected to a control device 150 which contains, inter alia, a central computer unit and memory units. The movements of all machine axes can be variably controlled with a high degree of temporal resolution with the aid of the control software which is active in the control device.

The forming machine is provided with an online measuring system which generates a quality signal that represents the production quality of the produced formed part to be able to quantitatively detect, for example, tolerance fluctuations during production in real time in a manner close to the process. The online measuring system has a CCD camera 170 connected to the control device 150; an associated image processing system is part of the control device 150. The quality signal is processed, inter alia, for the purpose of controlling a sorting device (not illustrated) to sort the produced formed parts immediately after completion into good parts (quality inside the tolerances) and bad parts (quality outside the tolerances), if appropriate also into more than two categories.

A display and operating unit 160 connected to the control device is used as an interface with respect to the machine operator. The latter can input particular parameters which are relevant to the bending process, for example, the desired bent part geometry (geometry data), and different workpiece properties (workpiece data) and tool data on the operating unit before the bending process begins. The NC operating program which is specific to the production process and is used for the coordinated control of the movements of the machine axes during the production process is generated therefrom.

Fitted to the display and operating unit is a knob 165 used as an operating element of a speed setting device which can be used by the operator to steplessly set the operating speed of the forming machine for the production process. The operating element may also be in the form of a pushbutton, a sliding controller or the like. If the display unit has a touch-sensitive screen (touchscreen), software-based operating elements are also possible.

The operating speed is set using the so-called “override speed.” In this case, the term “override” denotes a dimensionless measure of the operating speed which can normally be selected in a range between 0% and 100%. The override or the override speed has the same effect for all programmed production steps of a production process in the sense of scaling the programmed speed. In this case, the speed ratios between the individual programmed operating steps are retained unchanged. The override generally does not work in a linear manner; for an override of 100%, the operating speed may be less than twice as fast as for an override of 50%, for example.

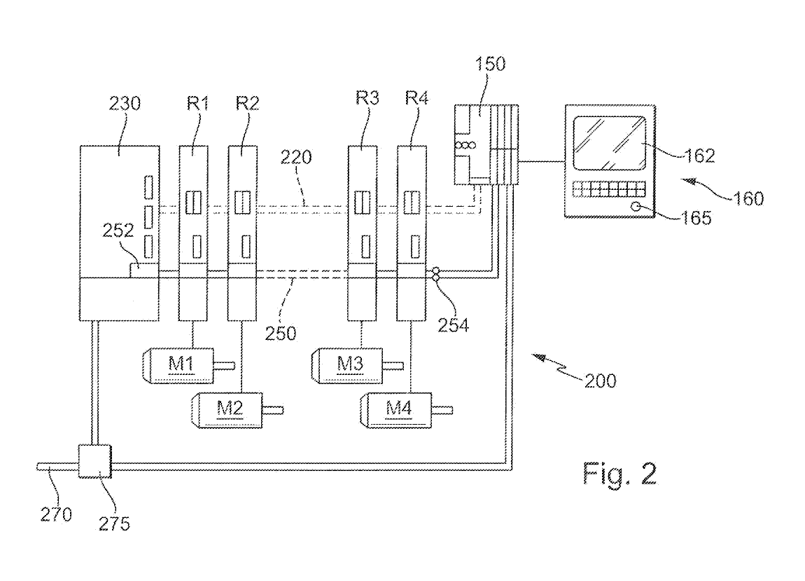

FIG. 2 schematically illustrates essential components of the drive system 200 of the forming machine. The drive system includes all electromotive drives of the machine axes of the forming machine, only servomotors M1, M2, M3 and M4 being illustrated in FIG. 2 for simplification reasons. A drive system of a forming machine generally has more than four drives, for example, more than ten or even more than twenty. However, there may also be fewer drives. The drives M1 to M4 may correspond to the drives with the same designation from FIG. 1. However, the drive system from FIG. 2 may also be used in other forming machines in an identical or similar form, for example, in a leg spring machine, a spring coiling machine or in a wire nail machine.

Each drive M1 to M4 has its own drive control unit R1, R2, R3 and R4 which contains the controller electronics. The drives and the drive control units are illustrated separately, but may also be combined in a compact unit. The drive control units are connected to the control device 150 of the CNC controller via a control circuit 220. A supply unit 230 which is likewise connected to the control device 150 via the control circuit 220 is provided for the purpose of electrically supplying the drives.

The drive system has an electrical intermediate circuit 250 which connects a plurality of the drives, in particular all of the electrical drives, to one another and to the electrical supply unit 230. The intermediate circuit is used as an energy store which allows the distribution of electrical energy between the drives to be improved. For example, an electrical drive requires a very large amount of electrical energy within a relatively short time under certain circumstances during an acceleration phase, for instance when starting the movement. On the other hand, electrical energy can be recovered by another drive during a delay phase in the fashion of a generator and can be fed into the intermediate circuit. Redistributing the electrical energy with the aid of the intermediate circuit connection makes it possible to feed electrical energy, which is released during the braking operation of one or more drives, back into the intermediate circuit and thus to make the energy available to other drives, for example for greater acceleration. The load on the supply unit as a whole is thus relieved.

The intermediate circuit is essentially a system which is suitable for storing electrical energy and can store the electrical energy in a capacitive and/or inductive manner. The capacity of the intermediate circuit, that is to say its capacity to store electrical energy, may be adapted to the energy requirement of the connected drives in such a manner that it the drive system is not utilized fully in many typical operating modes. For this purpose, the intermediate circuit capacity may be increased, for example, by connecting additional capacitors. However, in phases in which relatively large amounts of energy are fed back, the situation may occur in which the intermediate circuit capacity has been exhausted and excess energy arises which cannot be redistributed by the intermediate circuit in a usable manner. For these cases, the intermediate circuit has a consumer device 252 for consuming excess electrical energy arising in the intermediate circuit, for example, in the form of an electrical resistor (“braking resistor”).

A voltage signal which is proportional to the current intermediate circuit voltage or corresponds to the latter can be tapped off at a signal output 254 of the intermediate circuit. The intermediate circuit voltage increases, the greater the extent to which the intermediate circuit is utilized, that is to say the greater the extent to which its storage capacity is used. Typical intermediate circuit voltage ranges may be, for example, between 500 V (little utilization) and 820 V DC upon reaching the capacity limit. The signal output 254 is electrically connected to an input of the control device 150, with the result that an intermediate circuit state signal which represents the utilization state of the intermediate circuit is applied to this input in the form of a voltage signal. The information relating to the utilization state of the intermediate circuit is thus available to the controller. If the voltage at the signal output 254 increases above a threshold value which represents the capacity limit of the intermediate circuit, this indicates that excess energy arises which cannot be used inside the drive system and therefore must be consumed in another manner. If the voltage signal applied to the signal output 254 is thus compared with a comparison value which represents the capacity limit of the intermediate circuit, an evaluation system of the control device can easily decide whether the drive system as a whole is in a state which is favorable for energy efficiency (utilization limit of the intermediate circuit not yet reached) or in an unfavorable overload range in which energy is consumed without benefits for the drives.

The entire drive system of the forming machine and further loads of the forming machine, for example, the control device 150, the display and operating unit 160 and further components are supplied with electrical energy via a main connection 270. Connected into the lead of the main connection is a power meter 275 which detects the electrical power consumed by the forming machine at any time and uses this to generate a power signal (energy per unit time) which represents this power and is present at an output of the power meter, for example, in the form of a DC voltage proportional to the currently consumed power. The signal output of the power meter is electrically connected to the control unit 250 which also contains an evaluation circuit for the power signal. This forms a power detection device which provides the control software with a signal which represents the current power consumption of the entire forming machine at any time of operation.

The forming machine has an operator information system which processes, inter alia, the intermediate circuit state signal, the power signal, the quality signal, the excess energy signal and other data and signals relevant to the operation of the machine and uses the signals and data to determine operator information which allows the operator to control the operating speed of the forming machine, inter alia taking into account controlled energy consumption. Relevant operator information is displayed for the operator via the screen 162 which is part of the display and operating unit 160.

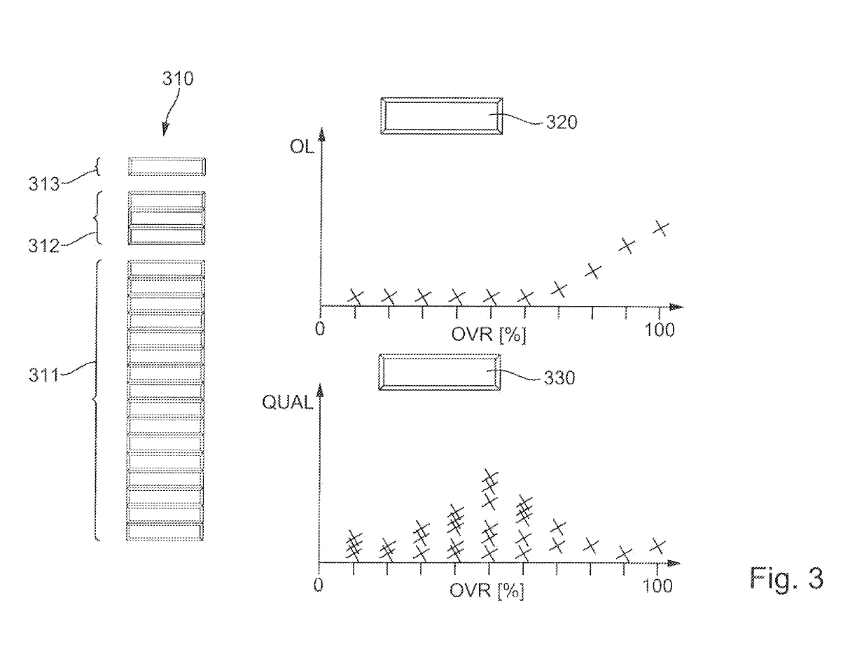

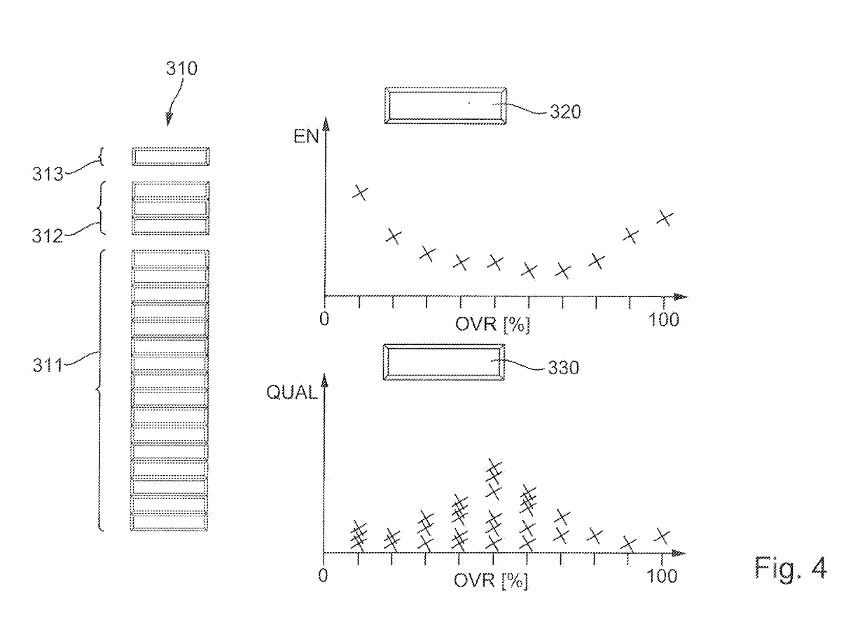

FIGS. 3 and 4 each show a section of the screen surface in different operating modes of the operator information system. A vertical multi-segment display 310 which displays the current utilization state of the intermediate circuit is located in the left-hand part of the section. A lower group 311 containing sixteen rectangular segments above one another is associated with a favorable utilization range of the intermediate circuit in which energy is only redistributed, but no excess energy arises. This favorable range ends at a distance below the utilization limit, with the result that even instances of the intermediate circuit utilization state being briefly exceeded beyond the favorable range do not yet lead to unusable energy consumption. The number of segments which light up increases approximately proportionally with the intermediate circuit voltage from bottom to top. All segments light up green which an operator immediately associates with a utilization state which is favorable in terms of energy, even with a cursory glance.

A middle group of segments 312 which is arranged at a distance above the lower group of segments and has three rectangular segments is associated with the utilization limit range. These segments still belong to intermediate circuit voltages which are below the maximum utilization, but the yellow color of the segments which light up indicates, by way of a warning, that the intermediate circuit is close to its utilization limit, with the result that slight increases in utilization would already lead to a loss of energy efficiency.

The uppermost individual segment 313 which is arranged at a distance above the middle group lights up red when excess electrical energy occurs in the intermediate circuit, that is to say when the energy efficiency of the process becomes lower on account of uselessly consumed electrical energy. The color coding and grouping of the segments make it easier for the operator to set the override speed in an anticipatory precise manner such that energy losses in the intermediate circuit are reliably avoided if possible.

The excess energy signal can also be processed, if appropriate, for the purpose of controlling an acoustic warning indication which emits a warning tone if excess energy is consumed.

The x-y graphs shown above one another to the right of the multi-segment display for the intermediate circuit information each indicate, at a glance, the dependence of selected process parameters on the operating speed. These graphs do not relate to a currently set operating speed, but rather indicate the dependence over the entire setting range of the operating speed. The dimensionless override speed (OVR) is selected in both cases as a measure of the operating speed, which override speed can be steplessly set by the operator between 0% and 100% using the operating knob 165. Process parameters whose dependence on the operating speed is intended to be graphically illustrated are each plotted on the y axes.

The upper graph can be referred to as “overload recording” and represents semi-quantitatively, that is to say in the correct relative ratios, the excess energy OL (overload OL) consumed or rejected in the intermediate circuit as a function of the operating speed or override speed. To generate the measuring points for the overload recording, a test series of formed parts is produced at different override speeds between 0% and 100% and the excess energy consumed in the intermediate circuit is quantitatively detected. This “test run” is run through by operating the ECO button 320 which is produced using software. The overload recording can be produced during set-up operation of the forming machine. It is also possible to carry out an overload recording during operation of the system.

An operator can immediately discern from the overload recording that virtually no excess energy arises in the intermediate circuit up to an override speed of 70% in the example, whereas excess energy is rejected in the intermediate circuit at override speeds above 70%. If this is intended to be avoided, the operator therefore sets override speeds of 70% or less.

The lower graph in FIG. 3 shows the dependence of the quality QUAL of the produced formed parts on the operating speed. In the selected representation of a variation recording, the variation in the production quality inside a definable number of produced formed parts is illustrated as a function of the operating speed with the aid of the measuring points. In this case, the term “variation” stands for tolerance deviations of the produced formed parts from the desired ideal geometry. The variation recording is based on quality signals which are detected with the aid of the online measuring system. The production of the variation recording can be started by operating the measuring channel button 330 produced using software. In the example, if the measuring system is provided with a camera, the measuring channel button can also be referred to as a camera button. Other online measuring systems operate with a laser measuring system or mechanically, for example. The variation curve can be recorded using a series of test formed parts during set-up operation before actual production, if appropriate also dynamically during production.

The illustration of the variation curve in FIG. 3 is representative of a trend which is initially surprising and is observed in many forming machines and production processes. This is because particularly low measured variation values result at relatively low override speeds (for example below 20%) and at very high override speeds (for example above 70% to 80%), whereas the greatest fluctuations or variations result at average speeds (for example in the range between 40% and 60%).

The joint consideration of the operator information displayed at the same time in FIG. 3 helps the operator to control the operating speed with respect to the consumption of excess energy. If the highest degree of quality is desired with minimal useless consumption of energy, the operator will then set override speeds of 30% or less to avoid the range of relatively high quality variation (around 50% OVR). If a good compromise between production quality and consumption of excess energy is desired, it is possible to operate with an override speed of approximately 80%, for example, where there is only little consumption of excess energy and the variation in the production quality is relatively low at the same time. High production capacities can be achieved.

FIG. 4 shows the screen in another operating mode which differs from the operating mode shown in FIG. 3 in that a different item of operator information is displayed in the upper right-hand x-y graph.

In the graph shown at the top right, the measuring points represent the electrical energy EN consumed by the forming machine for each formed part produced and is plotted in the graph as a function of the operating speed (represented by OVR). This recording is based on data which have been acquired by the control device with the aid of power signals from the power meter 275. In this case too, a test run for recording these energy values can be started by operating the ECO button 320 produced using software, either during set-up operation or in a phase during production.

The measured values indicated by way of example show a trend which is observed in many types of machines according to which the electrical energy needed for each bent part has a bathtub-shaped profile against the override speed or operating speed, this profile naturally being dependent on the type of machine and bent part. The joint consideration of the two graphs in FIG. 4 allows the operator to determine, at a glance, a very energy-efficient operating point with low tolerance variations (lower graph) and relatively little energy consumption. In the example, an operator would probably select override speeds in the range between 70% and 80% where, on the one hand, the tolerance variations are very low (lower graph) and, on the other hand, the energy consumption per bent part likewise still has very low values.

The exemplary displays of the operator information system which are shown in FIGS. 3 and 4 make it possible for the operator to determine, at a glance, particularly energy-efficient operating points with low tolerance variations. As a result, the power consumption for the production process can be kept low without making cuts in the quality of the formed parts produced. In addition, the operator is provided with the display 310 of the utilization state of the intermediate circuit, with the result that the operator is immediately able to discern the operating points at which no energy is dissipated when setting the override speed.

An easily comprehensible graphical representation of the state of the intermediate circuit, a display of the energy dissipation as a function of the override and/or a display of the energy required for each formed part against the override easily make it possible for the operator to determine and set the most energy-efficient operating point of the machine, at which operating point no or only little energy is dissipated. With the combination of an online measuring system or other sensors, an operator can also set an override speed at which particularly low variations in the result values are achieved. The production process can therefore also be controlled with respect to a combination of energy efficiency and variation or quality.

Some forming machines may provide a desired functionality with different tool arrangements, that is to say with different spatial/physical arrangements of the forming tools. The display can possibly be used by the operator to decide whether it may possibly be advantageous to convert the forming machine to another tool arrangement from the point of view of energy. Furthermore, there may be different sequences for producing a particular formed part, for example, in multi-head machines or during work in a second system (for example, with holding tongs). In this case, the display can be used to decide which of a plurality of possible approaches is particularly favorable in terms of energy. Different tool arrangements and/or different sequences of the operations can be compared with respect to energy consumption before series production. These possibilities can be used to control energy irrespective of the operating speed setting.

In this respect, we also provide forming machines for producing formed parts by forming wire, tube or other elongated workpieces, having a plurality of machine axes, a drive system having a plurality of electrical drives for driving the machine axes, and a control device for the coordinated control of operating movements of the machine axes in a production process according to an operating program specific to the production process, which machine is characterized by an operator information system for determining and outputting at least one item of operator information for controlling the tool arrangement and/or the sequence of operations of a production process with respect to at least one control criterion which takes into account the energy consumption required for production.

The above description refers to representative examples. From the disclosure given, those skilled in the art will not only understand our forming machines and their attendant advantages, but will also find apparent various changes and modifications to the structures and methods disclosed. It is sought, therefore, to cover all changes and modifications as fall within the spirit and scope of this disclosure, as defined by the appended claims, and equivalents thereof.

What is claimed is:

1. A forming machine that produces formed parts by forming wire, tube or other elongated workpieces comprising:
a plurality of driven machine axes;
a drive system comprising a plurality of electrical drives that drive the driven machine axes;
a control device that controls in a coordinated fashion operating movements of the driven machine axes in a production process according to an operating program selected for the production process;
a speed setting device provided to set an operating speed of the forming machine for the production process; and
an operator information system that determines and outputs at least one item of operator information that controls the operating speed with respect to at least one control criterion related to energy consumption required for production.

2. The forming machine according to claim 1, wherein the drive system comprises an intermediate circuit which connects a plurality or all of the drives and at least one electrical supply unit of the drive system to one another, and wherein the control device of the forming machine detects an intermediate circuit state signal which represents a utilization state of the intermediate circuit and processes said signal for the purposes of control.

3. The forming machine according to claim 2, wherein the operator information system controls a display which represents a current utilization state of the intermediate circuit on a display unit of the forming machine on the basis of the intermediate circuit state signal.

4. The forming machine according to claim 2, wherein excess electrical energy arises when an intake capacity of the intermediate circuit is exceeded, and wherein the operator information system processes an excess energy signal which represents the excess electrical energy.

5. The forming machine according to claim 4, wherein the operator information system controls a display which represents an amount of excess electrical energy which arises on a display unit of the forming machine.

6. The forming machine according to claim 3, wherein the display which represents the current utilization state of the intermediate circuit is combined with a display which represents a consumption of excess energy.

7. The forming machine according to claim 1, further comprising:
a power detection device that detects an electrical power consumed by the forming machine and generates a power signal representing a quantity of the power.

8. The forming machine according to claim 7, wherein the operator information system processes the power signal and determines a process parameter proportional to electrical energy needed by the forming machine for each formed part produced.

9. The forming machine according to claim 1, further comprising:
an online measuring system that generates at least one quality signal representing production quality of a formed part produced.

10. The forming machine according to claim 9, wherein the operator information system processes the quality signal and determines a process parameter proportional to a variation in production quality within a definable number of produced formed parts.

11. The forming machine according to claim 1, wherein the operator information system determines and displays at least one item of operator information representing a process parameter characteristic of the programmed production process as a function of the operating speed.

12. The forming machine according to claim 11, wherein the operator information is displayed graphically.

13. The forming machine according to claim 12, wherein the operator information is displayed graphically in the form of a two-dimensional graph.

14. The forming machine according to claim 11, wherein the process parameter is selected from the group consisting of:
an amount of excess energy consumed in an intermediate circuit,
an electrical energy consumed by the forming machine for each formed part produced, and
a variation in production quality within a definable number of produced formed parts.

15. The forming machine according to claim 1, wherein the operator information system substantially simultaneously displays at least two of the following items of operator information on a display device of the forming machine in at least one operating mode:
a current utilization state of an intermediate circuit;
an amount of excess electrical energy arising in an intermediate circuit;
excess energy consumed in an intermediate circuit as a function of the operating speed;
electrical energy consumed by the forming machine for each produced formed part as a function of the operating speed; and
a variation in production quality within a definable number of produced formed parts as a function of the operating speed.

16. A forming machine configured to produce formed parts by forming wire, tube or other elongated workpieces comprising:
a plurality of driven machine axes;
a drive system comprising a plurality of electrical drives that drive the driven machine axes;
a control device that controls in a coordinated fashion operating movements of the driven machine axes in a production process according to an operating program selected for the production process;
a speed setting device that sets an operating speed of the forming machine for the production process; and
an operator information system that determines and outputs at least one item of operator information which represents a process parameter characteristic of the programmed production process as a function of the operating speed.

17. The forming machine according to claim 16, wherein the operator information is displayed graphically.

18. The forming machine according to claim 16, wherein the operator information is displayed graphically in the form of a two-dimensional graph.

19. The forming machine according to claim 16, wherein the process parameter is selected from the group consisting of:
an amount of excess energy consumed in an intermediate circuit;
electrical energy consumed by the forming machine for each formed part produced; and
a variation in production quality within a definable number of produced formed parts.
